(19) United States
(12) Patent Application Publication
(10) Pub. No.: US 2025/0145360 A1
(43) Pub. Date: May 8, 2025

(54) CONTAINER FOR EXOTHERMIC WELDING MATERIAL

(71) Applicant: ERICO International Corporation, Solon, OH (US)

(72) Inventors: Nicholas Michael Camburako, Streetsboro, OH (US); Jenny Debniak, Moreland Hills, OH (US); Chad Zaremba, Cuyahoga Falls, OH (US); Marianna Palmer, Chesterland, OH (US); Huy Nguyen, Cuyahoga Falls, OH (US); Melissa Botti, Chagrin Falls, OH (US)

(21) Appl. No.: 18/939,733

(22) Filed: Nov. 7, 2024

Related U.S. Application Data
(60) Provisional application No. 63/596,689, filed on Nov. 7, 2023.
(60) Provisional application No. 63/649,116, filed on May 17, 2024.
(60) Provisional application No. 63/649,765, filed on May 20, 2024.
(60) Provisional application No. 63/670,386, filed on Jul. 12, 2024.
(60) Provisional application No. 63/681,331, filed on Aug. 9, 2024.

(51) Int. Cl. B65D 81/32; B23K 20/16; B65D 43/02; B65D 53/02

(52) U.S. Cl. CPC B65D 81/32; B65D 43/0204; B65D 53/02; B23K 20/165

(57) ABSTRACT

A container for exothermic welding material can include a first receptacle with a first internal volume that contains welding material and a first opening into the first internal volume, and a second receptacle with a second internal volume that contains starting powder and a second opening into the second internal volume. The second receptacle can be removably secured to the first receptacle to form a unified assembly, with the first and second openings closed to separate the starting powder from the welding material.

### CROSS-REFERENCE TO RELATED APPLICATIONS

This application claims the benefit of U.S. Provisional Application No. 63/596,689, filed Nov. 7, 2023, U.S. Provisional Application No. 63/649,116, filed May 17, 2024, U.S. Provisional Application No. 63/649,765, filed May 20, 2024, U.S. Provisional Application No. 63/670,386, filed Jul. 12, 2024, and U.S. Provisional Application No. 63/681,331, filed Aug. 9, 2024, each of which is hereby incorporated by reference in their entirety.

### BACKGROUND

Exothermic welding can be used in different settings to form high quality, high ampacity, and low resistance electrical connections between different conductors. In general, an exothermic welding process can fuse together separate conductors to provide a bond with a current carrying capacity substantially equal to that of the conductors themselves. Further, exothermic welds can be relatively durable and long-lasting, and can avoid problems of loosening and corrosion that can occur for mechanical and compression joints. As a result of these benefits exothermic weld connections are widely used in grounding systems and other settings to enable connected sets of conductors to operate, effectively, as a continuous conductor with relatively low resistivity.

### SUMMARY

Some aspects of the disclosure provide a container for exothermic welding material. The container can include a first receptacle with a first internal volume that contains welding material and a first opening into the first internal volume, and a second receptacle with a second internal volume that contains starting powder and a second opening into the second internal volume. The second receptacle can be removably secured to the first receptacle to form a unified assembly, with the first and second openings closed to separate the starting powder from the welding material.

Some aspects of the disclosure provide a method of manufacturing a container for exothermic welding material. The method can include filling welding material into a first internal volume of a first receptacle via a first opening defined at a first end of the first receptacle, closing the first opening to retain the welding material within the first receptacle by removably securing a first seal to the first receptacle, filling starting powder into a second internal volume of a second receptacle via a second opening defined at a second end of the second receptacle, closing the second opening to retain the starting powder within the second receptacle by removably securing a second seal to the second receptacle, and after closing the first and second openings, securing the first end of the first receptacle to the second end of the second receptacle to form a unified assembly.

Some aspects of the disclosure provide a container for exothermic welding material. The container can include a first receptacle that defines a first volume containing welding material, a second receptacle with a wall defining a cavity that contains starting powder and a lid removably secured to the wall to, in cooperation with the wall, fully enclose the cavity. The second receptacle can be removably secured to the first receptacle, to form a unified assembly.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1A is cross-sectional view of a welding system.

FIG. 1B is an axonometric view of a container for exothermic welding material according to aspects of the present disclosure.

FIG. 2 is a side view of the container of FIG. 1B.

FIG. 3 is a diagrammatic view of the container of FIG. 1B.

FIG. 4 is an exploded view of the container of FIG. 1B.

FIG. 5 is an exploded view of the container of FIG. 1B.

FIG. 6 is a side view of another example of a container for exothermic welding material.

FIG. 7 is an exploded view of the container of FIG. 6.

FIG. 8 is an axonometric view of another example of a container for exothermic welding material.

FIG. 9 is an exploded view of the container of FIG. 8.

FIG. 10 is an axonometric view of another example of a container for exothermic welding material.

FIG. 11 is an exploded view of the container of FIG. 10.

FIG. 12 is an axonometric view of another example of a container for exothermic welding material.

FIG. 13 is an exploded view of the container of FIG. 12.

FIG. 14 is a top view of the container of FIG. 12.

FIG. 15 is an axonometric view of a second receptacle of the container of FIG. 12.

FIG. 16 is an axonometric view of another example of a container for exothermic welding material.

FIG. 17 is an exploded view of the container of FIG. 16.

FIG. 18 is a top view of the container of FIG. 16.

FIG. 19 is an axonometric view of a second receptacle of the container of FIG. 16 in a first position.

FIG. 20 is an axonometric view of the second receptacle of FIG. 19 in a second position.

FIG. 21 is a cross-sectional view of another example of a container for exothermic welding material.

FIG. 22 is a cross-sectional view of another example of a container for exothermic welding material.

FIG. 23 is a top perspective view of a second receptacle of the container of FIG. 22.

FIG. 24 is another top perspective view of the second receptacle of FIG. 23.

FIG. 25 is a bottom perspective view of the second receptacle of FIG. 23.

FIG. 26 is a bottom perspective view of another example of a second receptacle of FIG. 23.

FIG. 27 is a top perspective view of another example of a first receptacle of the container of FIG. 3.

FIG. 28 is an axonometric view of another example of a second receptacle of the container of FIG. 3.

FIG. 29 is a cross-sectional view of the second receptacle of FIG. 28, secured to a first receptacle.

FIG. 30 is an axonometric view of a lid for use with the second receptacle of FIG. 28.

FIG. 31 is an axonometric view of another example of a second receptacle of the container of FIG. 3 with the lid of FIG. 30 removed.

FIG. 32 is a cross-sectional view of the second receptacle of FIG. 31, secured to a first receptacle.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As noted above, exothermic welding can be used to connect together metal structures, such as copper conductors of an electrical system. Generally, exothermic mixtures can include a combination of a reductant metal and a transition metal oxide, which upon ignition react exothermically to supply sufficient heat to propagate and sustain a continuing reaction of the mixture. The resulting heat can be used directly, or the resulting molten metal can be used to create a useful weld, as in the case of exothermic welding.

As one example, some conventional exothermic welding material mixtures can include aluminum and copper oxide. Upon ignition, the resulting exothermic reaction can provide a mixture of molten copper and aluminum oxide (the latter being commonly referred to as “slag”). The molten copper has a higher density than the slag and can accordingly be caused by gravity to flow within a mold to weld together metal conductors (e.g., copper to copper or steel to steel). The less dense aluminum oxide slag is generally removed from the weld connection, or from other parts of the mold in which it may accumulate, and discarded. As another example, other conventional mixtures can include iron oxide and aluminum, which can react with similar effect.

Exothermic mixtures of this type do not react spontaneously and need a method of initiating the reaction, which involves generating enough localized energy to enable the exothermic reaction to begin. One method of initiating ignition is through use of starting powder and an ignition source such as an electric ignitor or a flint ignitor. For example, a disk (e.g., metallic disk) can be positioned within the mold used to guide the exothermic weld process. Following this, an appropriate amount of exothermic material can be placed into the mold on top of the disk, and a starting powder or material may be sprinkled over the top of the exothermic welding material prior to ignition. The mold may then be closed, and the exothermic reaction initiated by igniting the starting powder via an electrical ignitor or flint ignitor. In another example, a cup (e.g., a metallic cup) may be used in lieu of the disk. For example, the cup may contain both the exothermic material or starting powder and to serve as the disk, which reduces the total number of components needed (i.e., no longer need a separate disk) and facilitates efficient operation.

Starting powder, as recognized in the art, may have a similar formulation as welding material (i.e., for a main welding charge) but may be formed as finer powder or otherwise modified so as to be more readily ignitable. Thus, specialized transportation and manufacturing rules may apply, and associated difficulties in handling and shipping of starting powder may generally require relatively high costs and complexity for producers and consumers. Further, different welding applications may require widely varying amounts of welding material and corresponding charges of starting powder. Intermixing (or “free-boarding”) of welding material and starting powder can also render a welding package unusable (e.g., because the starting powder is too diffused to be ignited as intended), and in-field management of multiple packages of welding material, starting powder, and other components (e.g., disks) can be challenging because of the varied nature of installation contexts. Accordingly, packaging for exothermic welding may need to be designed to effectively separate starting powder and welding material, to accommodate the above-noted manufacturing and transport complexities, and also to be adaptable to a wide range of volumes of welding charges while providing a high degree of ease of use for users.

To address these and other issues, examples of the disclosed technology can provide a container system for exothermic welding material that can segregate predetermined amounts of exothermic material and starting powder while also allowing for more efficient manufacturing, transport, and use. Some examples of the disclosed technology can provide pre-portioned welding materials, conveniently available to be used for performing exothermic welding, even while wearing personal protective equipment (e.g., gloves).

In some examples, separate receptacles can be secured together after being separately formed and filled with welding material or starting powder, respectively (e.g., and also sealed closed, etc.). Thus, for example, manufacturing complexities and costs associated with starting powder can be avoided for the receptacle of welding material, but a unified container that includes welding material and starting powder can be provided for consumer use. In this regard, a user may prefer to have exothermic material and starting powder within in a single container or package (e.g., metallic cup) to prevent misplacing or forgetting one or more components at a worksite. In some examples, it may be particularly beneficial to automation of a manufacturing process of the exothermic welding materials to produce receptacles of exothermic material and starting powder separately, and then combine the receptacles into a single convenient container.

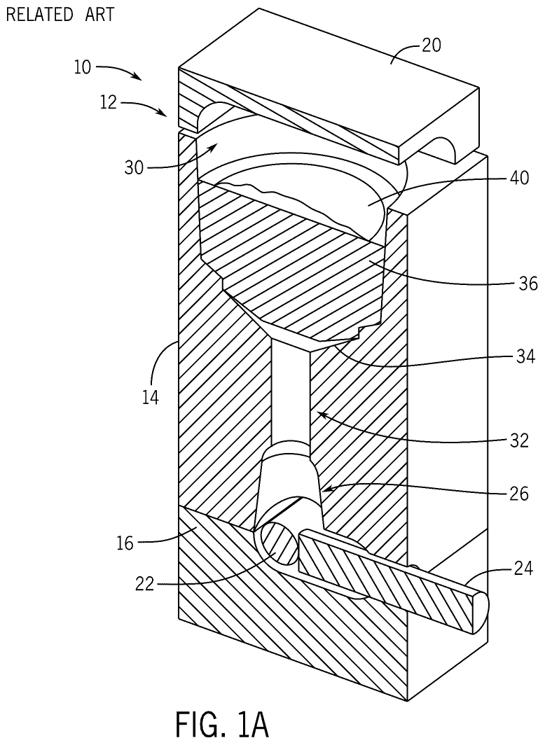

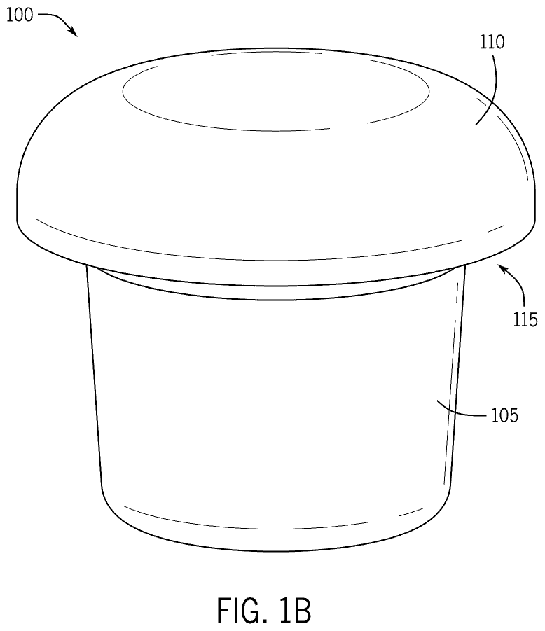

In conventional systems, in order to appropriately contain the large amount of heat produced by exothermic reactions, highly engineered and relatively expensive graphite molds can be used. In a conventional arrangement illustrated in FIG. 1A, for example, a conventional welding apparatus 10 uses a split graphite mold 12. In the example illustrated, the mold 12 includes an upper mold body section 14, a lower mold body section 16, and a mold cover 20 formed as a hinged or other lid. The body sections 14, 16 of the mold 12 align to define a weld chamber 26, as well as channels leading thereto. Conductors to be joined, such as copper bars 22, 24, are appropriately cleaned and then placed in alignment with the channels to project into the weld chamber 26. To hold and react exothermic material, the upper mold body section 14 includes a crucible chamber 30 disposed generally above the weld chamber 26, and connected to the weld chamber 26 by a tap hole 32. With the mold body sections 14, 16 securely closed, a metal disk 34 can be positioned in the crucible chamber 30 over the tap hole 32. An appropriate amount of exothermic material 36 can be placed into the crucible chamber 30 on top of the disk 34, and a starting material (e.g., starting powder 40) may be sprinkled over the top of the exothermic welding material 36 prior to ignition. The mold cover 20 is then closed and the exothermic reaction initiated by igniting the starting powder 40 by the use of an electrical ignitor or flint ignitor.

FIGS. 1B-3 illustrate an example of a container 100 for exothermic welding materials (e.g., a multi-piece assembled package, as shown) that may be used with the welding apparatus 10 of FIG. 1A. The container 100 may include a first receptacle 105 and a second receptacle 110 removably secured to the first receptacle 105 to form a unified assembly of the container (e.g., to collectively provide a unified multi-receptacle container, as shown, or a sub-assembly thereof). In one example, the first receptacle 105 and the second receptacle 110 may each define separate (sub) containers configured to retain an exothermic ignitable material. For example, as further detailed below, the first and second receptacles 105, 110 can form separate sealed enclosures that independently surround corresponding internal volumes to hold corresponding charges (e.g., of a starting powder or a welding material).

In one example, the first receptacle 105 of the container 100 may include a first end 205 (e.g., a base) and a second end 210. In one particular example, the first receptacle 105 may define a “cup” shape and the first end 205 may be configured to sit securely on flat (or other) surfaces to hold the cup upright. In one example, the second end 210 of the first receptacle 105 may be selectively covered with the second receptacle 110 (e.g., formed as a cap). In one example, the second receptacle 110 may be secured to the first receptacle 105 via a snap-fit connection 115. In other examples, the second receptacle 110 may secure to the first receptacle 105 via a threaded connection, interference fit, friction fit, or any other known removable connection methods.

In one example, the first receptacle 105 may define a cup shape (e.g., with a circular cross-section and an opening at the second end 210). However, in other examples, the first receptacle 105 may define other shapes (e.g., triangular, rectangular, hexagonal, or other polygonal shapes). Further, the first receptacle 105 may be made from metallic materials to mitigate the need for a separate disk as mentioned previously. In another example, the second receptacle 110 may define a domed shape. In other examples, the second receptacle 110 may define a frustoconical shape.

As further detailed below, the container 100 may provide a convenient storage or packaging method for retaining exothermic welding materials. For example, the first receptacle 105 may retain a first type of ignitable material (e.g., exothermic welding material for a main welding charge, as discussed above). In contrast, the second receptacle 110 may retain a second type of ignitable material (e.g., starting powder, as discussed above).

Further, as also noted above, the first receptacle 105 may mitigate the need for one or more disks. For example, the first receptacle 105 may be made from a metallic material configured to selectively receive and contain both the welding material and the starting powder within a mold crucible, for ignition and weld formation during an exothermic welding operation. Thus, in some installations, a use may open the first and second receptacles 105, 110, pour starting powder from the second receptacle 110 into the first receptacle 105, then ignite the starting powder within the first receptacle.

Thus, as generally discussed above, the components required for exothermic welding operations (aside from a mold and relevant conductors), can be retained in a single convenient package or container. Further, the illustrated configuration and others according to this disclosure can ensure that each of the components is still physically separated, which can help to prevent free-boarding, improve job-site access and organization, and create greater efficiency in manufacturing and transport.

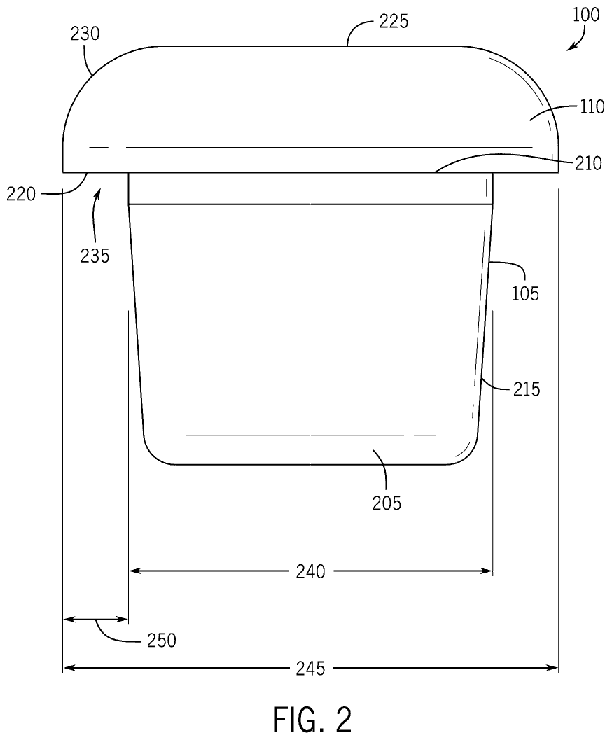

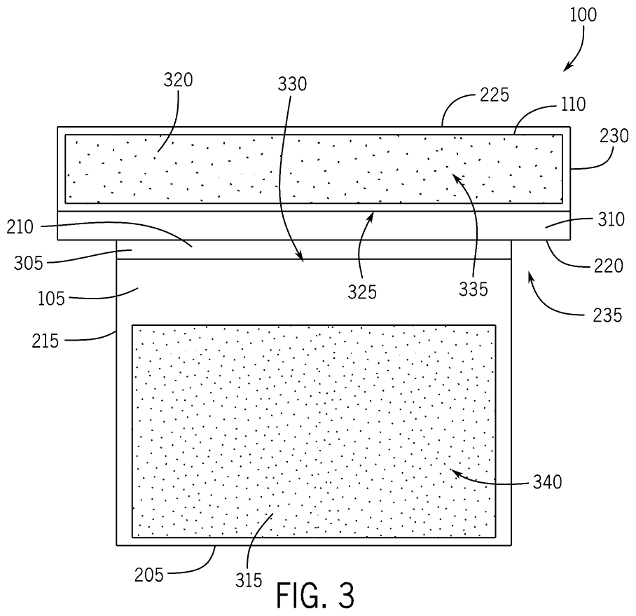

With continued reference to FIGS. 2 and 3, the first receptacle 105 may include an opening 330 at the second end 210 to permit an operator or user to pour welding material into or remove welding material from an interior volume 340 of the first receptacle 105. In one example, the volume 340 of the first receptacle 105 may be bounded by the first end 205 of the first receptacle 105, one or more sidewalls 215 of the first receptacle 105, and a first removable seal 305. As mentioned previously, in one example, the first receptacle 105 may be configured to retain exothermic material used in the exothermic welding process (e.g., welding material for a main welding charge). In one particular example, the interior volume 340 of the first receptacle 105 may contain welding material 315.

The second receptacle 110 may include an opening 325 at a first end 220 to permit an operator to pour welding material into or remove welding material from an interior volume 335 the second receptacle 110. In one example, the volume 335 may be bounded by a second end 225 of the second receptacle 110, one or more sidewalls 230 of the second receptacle 110, and a second removable seal 310. As mentioned previously, in one example, the second receptacle 110 may be configured to retain starting powder 320 used in the exothermic welding process.

In some cases, the first receptacle 105 can be filled with welding material 315 via the opening 330. Following this, the first receptacle 105 may be enclosed (e.g., sealed) via the seal 305 to prevent spillage, loss, or free-boarding of material. Correspondingly, the second receptacle 110 can be filled with starting powder 320 via the opening 325. Following this, the second receptacle 110 may be enclosed (e.g., scaled) via the seal 305 to prevent spillage, loss, or free-boarding of material. In one example, both the first and second receptacles 105, 110 may be filled and sealed prior to being secured together via the snap-fit connection 115.

Correspondingly, both the first and second receptacles 105, 110 may be selectively opened (e.g., permitting access to openings 325, 330) by removing the respective seals 305, 310. In one example, the seals 305, 310 may be in the form of foil seals retained on the first and second receptacles 105, 110 via an adhesive material. In some examples, the first and second receptacles 105, 110 may be resealable via the seals 305, 310 (e.g., forming multi-use receptacles, to save material for future use, etc.). In other examples, the first and second receptacles 105, 110 may be single-use receptacles. For example, the seals 305, 310 may not be resealable onto the receptacles 105, 110.

The container 100 may be configured to include a variety of sizes for the first receptacle 105 or the second receptacle 110 to facilitate different use cases. For example, the first receptacle 105 and the second receptacle 110 may be larger for larger projects/amounts of welding material, while the first receptacle 105 and the second receptacle 110 may be smaller for smaller projects/amounts of welding material. As should be appreciated, the size of the first receptacle 105 and the second receptacle 110 may correspond to an amount (e.g., volume) of welding material held within the first receptacle 105 or the second receptacle 110. In one particular example, a width 240 (e.g., diameter) of the first receptacle 105 may be smaller than a width 245 (e.g., diameter) of the second receptacle 110. In one example, the difference in width between the first receptacle 105 and the second receptacle 110 may result in a lip 235 of the second receptacle 110 projecting circumferentially around the container 100 with a radial depth 250 and variable axial extension (e.g., with corresponding overlap with the first receptacle 105 along a direction of movement to attach or remove the receptacles 105, 110 relative to the corresponding unified assembly). The lip 235 may permit an operator to grip the container 100 to separate the first receptacle 105 from the second receptacle 110.

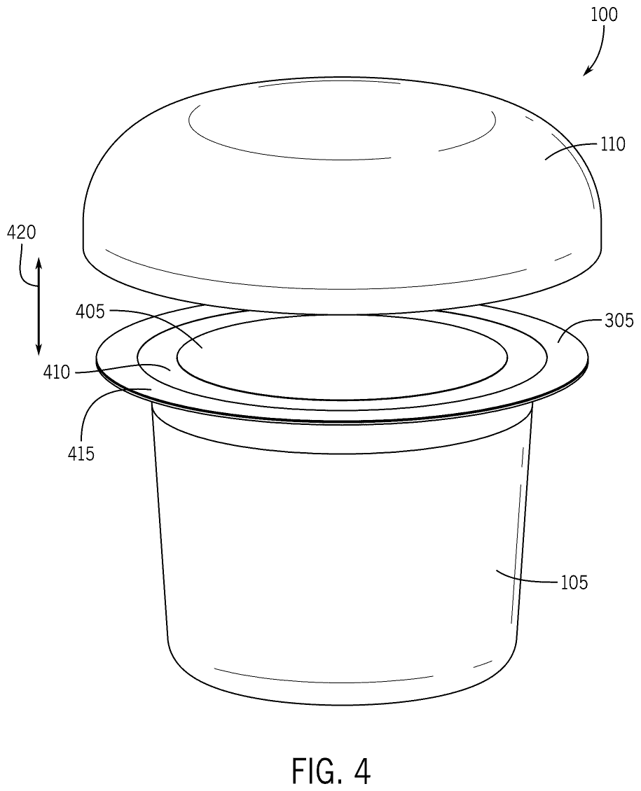

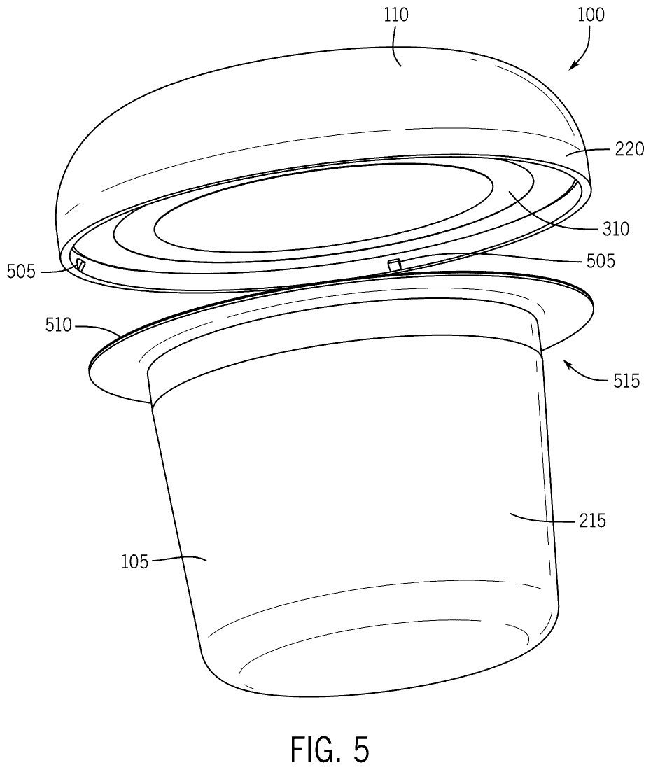

As shown in FIGS. 4 and 5, the seals 305, 310 may include a series of markings (e.g., circular rings 405, 410, 415). In some examples, these markings can indicate to a particular amount, mixture, or composition of material (e.g., welding material 315 or starting powder 320) within the first or second receptacles 105, 110, or other relevant information.

As mentioned previously, the first and second receptacles 105, 110 may be selectively attached or detached via the snap-fit connection 115. To facilitate the snap-fit connection 115, the second receptacle 110 may include one or more protrusions 505 extending away from an interior of the second receptacle 110 adjacent the first end 220. The one or more protrusions 505 may be configured to engage a rim 510 of a circumferential flange 515 extending away from the second end 210 of the first receptacle 105.

In one example, to attach the first and second receptacles 105, 110 together, the operator may align the first end 220 of the second receptacle 110 with the second end 210 of the first receptacle 105. The operator may then apply a force (e.g., a compression force) to snap the one or more protrusions 505 over the rim 510 of the flange 515, which secures the first and second receptacles 105, 110 together via the snap-fit connection 115. To detach the first and second receptacles 105, 110, the operator may grip the lip 235 and apply a force in the direction shown by arrow 420 to disengage the one or more protrusions 505 from the rim 510 of the flange 515. In one example, once the first and second receptacles 105, 110 are separated, the operator may then remove the seals 305, 310 to access the welding material 315 or the starting powder 320.

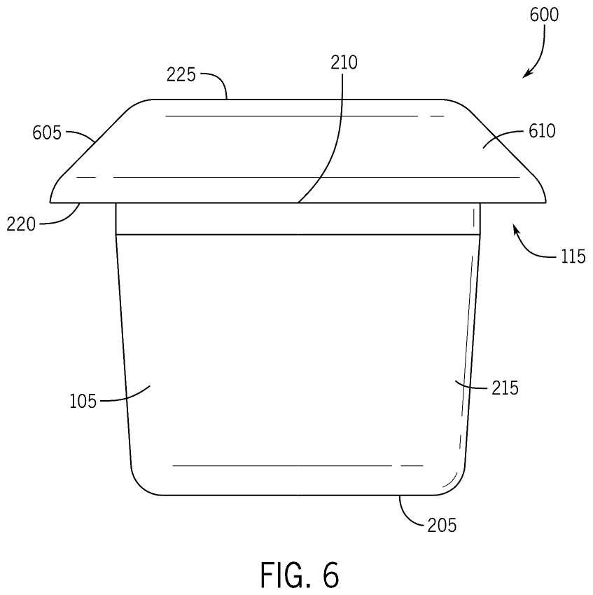

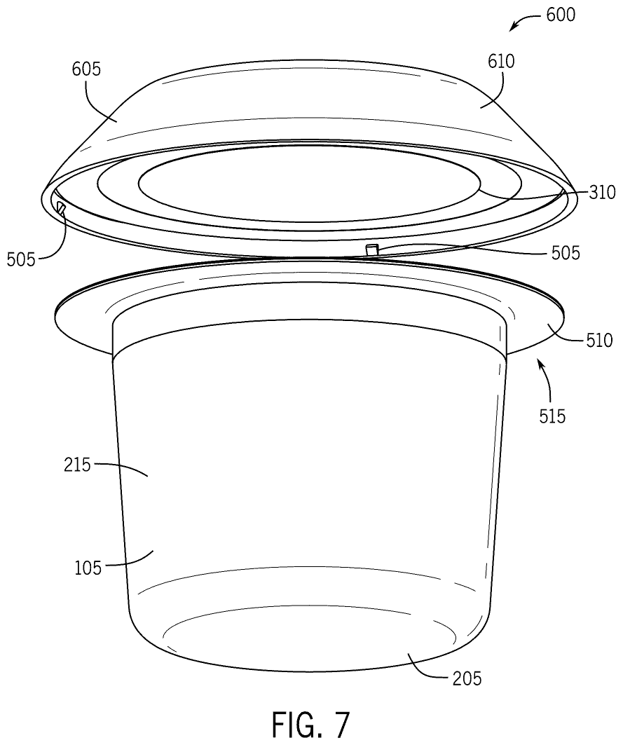

FIGS. 6 and 7 illustrate another example of a container 600, as another example configuration of the schematically-illustrated arrangement of FIG. 3. The container 600 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 600.

In one example, the container 600 includes a second receptacle 610 (e.g., a cap) having one or more angular sidewalls 605. For example, the sidewalls 605 may define an angle of between 30 and 90 degrees from the second end 225 to the first end 220 of the second receptacle 610.

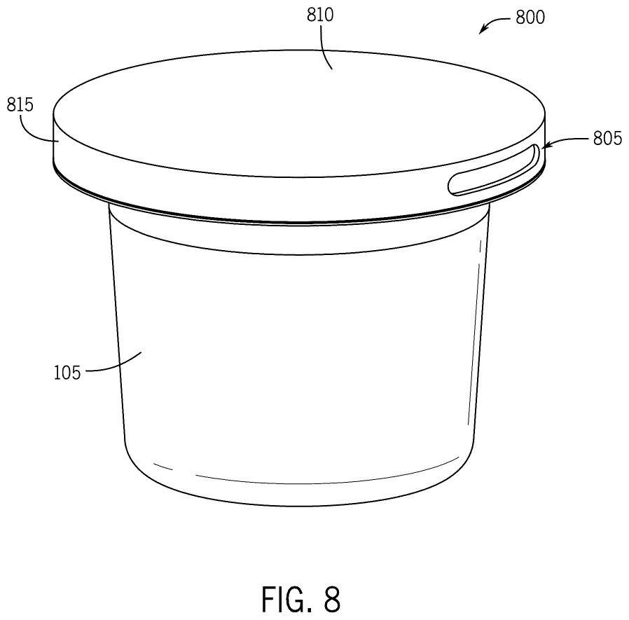

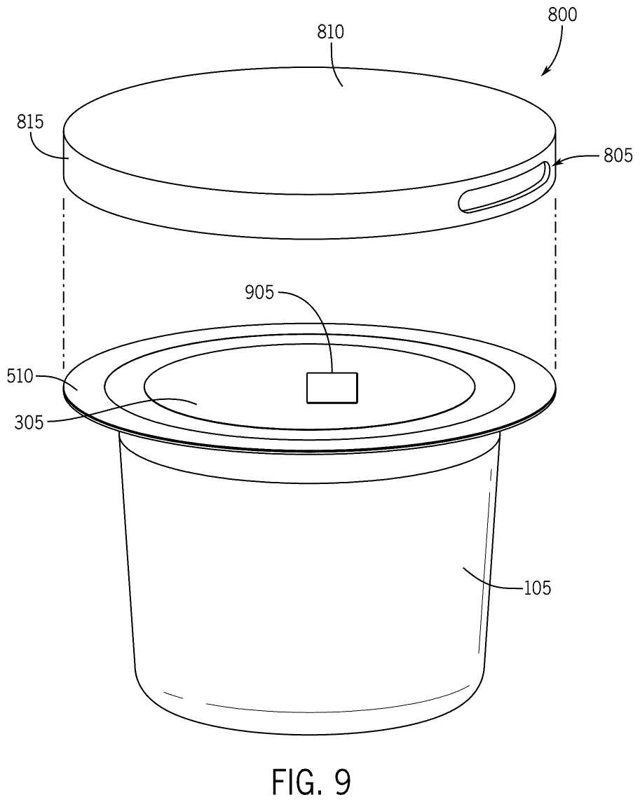

FIGS. 8 and 9 illustrate another example of a container 800, as another example configuration of the schematically-illustrated arrangement of FIG. 3. The container 800 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 800.

In one example, the container 800 includes a second receptacle 810 configured to hold starting powder. The second receptacle 810 may include a sidewall 815 that defines an outer circumference of the second receptacle 810. In one example, the sidewall 815 may define an opening 805 configured to permit an operator to pour starting powder out of the second receptacle 810. In some examples, the outer circumference of the second receptacle 810 defined by the sidewall 815 may be equal to the outer circumference of the rim 510 of the first receptacle 105. Thus, the rim 510 of the first receptacle 105 and the sidewall 815 of the second receptacle 810 may be flush.

In another example, in order to secure the second receptacle 810 to the first receptacle 105, an adhesive 905 may be arranged on the first seal 305 of the first receptacle 105. In one example, the adhesive 905 may be arranged across the entire surface of the first seal 305. However, in other examples, the adhesive 905 may only be arranged in the center of the first seal 305 (e.g., as a dot of adhesive). Further, to retain the starting powder within the second receptacle 810, a second seal (e.g., a plug, label, sticker, film, etc.) may be arranged over the opening 805. In some examples, the second seal may be arranged around the sidewall 815 of the second receptacle 810.

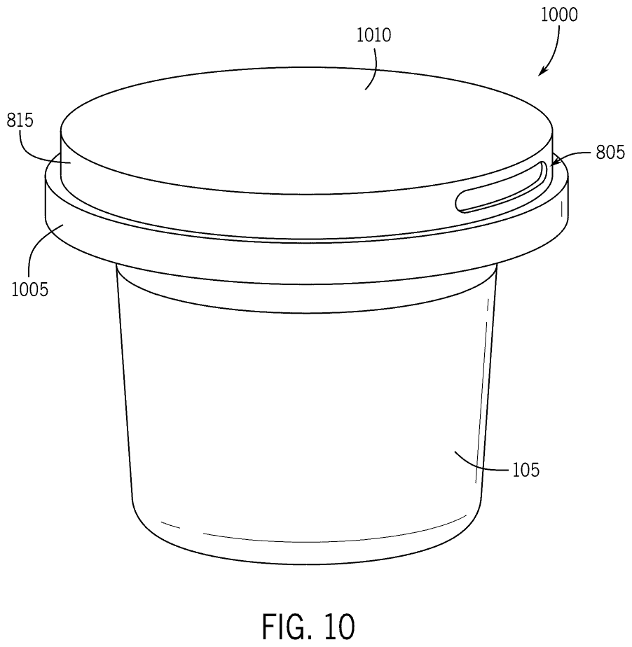

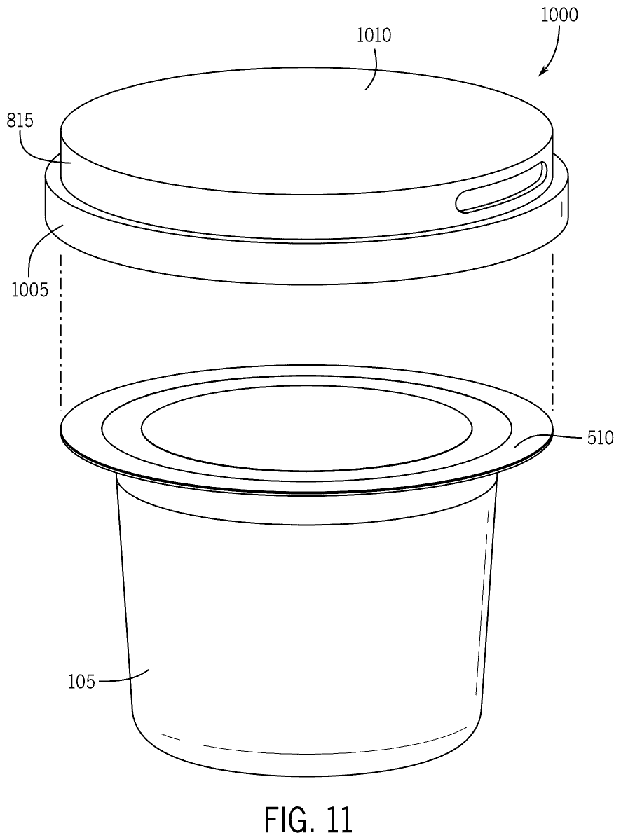

FIGS. 10 and 11 illustrate another example of a container 1000, as another example configuration of the schematically-illustrated arrangement of FIG. 3. The container 1000 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 1000.

In one example, the container 1000 includes a second receptacle 1010 configured to hold starting powder. The second receptacle 1010 may include a sidewall 815 that defines an outer circumference of the second receptacle 1010. In one example, the sidewall 815 may define an opening 805 configured to permit an operator to pour starting powder out of the second receptacle 1010.

In another example, in order to secure the second receptacle 1010 to the first receptacle 105, a mounting flange 1005 may extend from the sidewall 815 of the second receptacle 1010. In one example, the mounting flange 1005 may engage with the rim 510 of the first receptacle 105 via a snap-fit to secure the second receptacle 1010 to the first receptacle 105. Further, to retain the starting powder within the second receptacle 810, a second seal (e.g., a plug, label, sticker, film, etc.) may be arranged over the opening 805. In some examples, the second seal may be arranged around the sidewall 815 of the second receptacle 810.

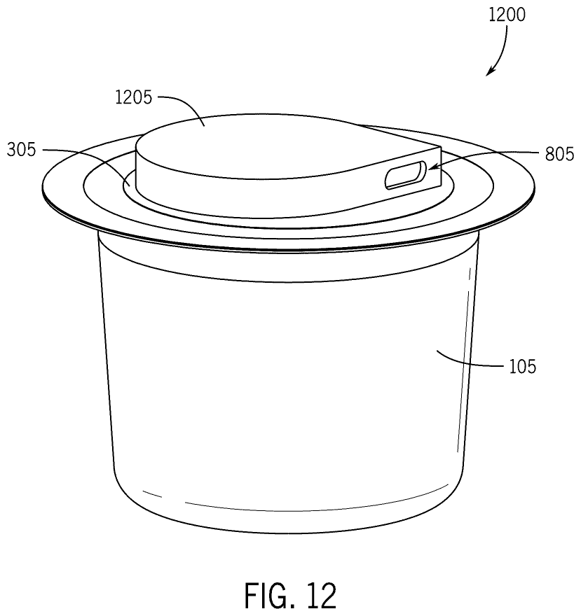

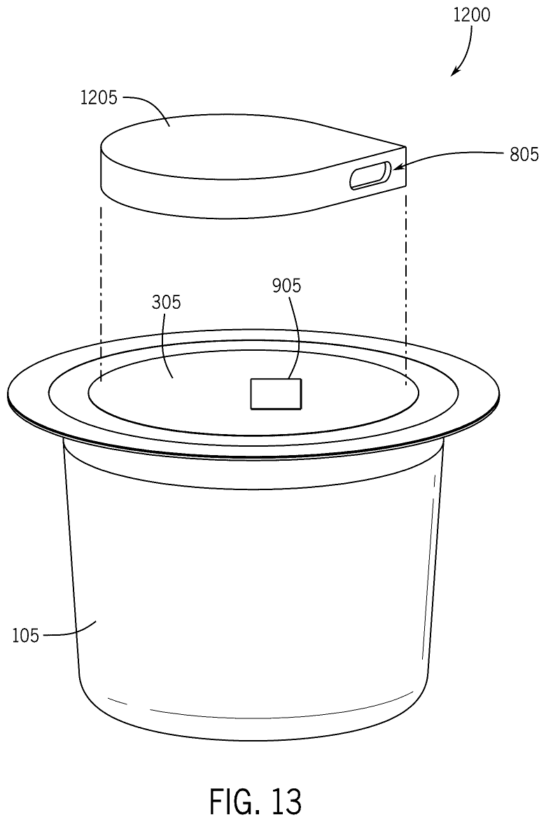

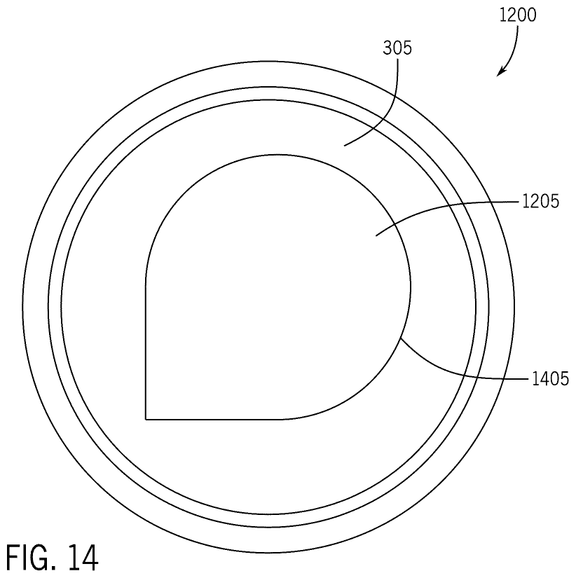

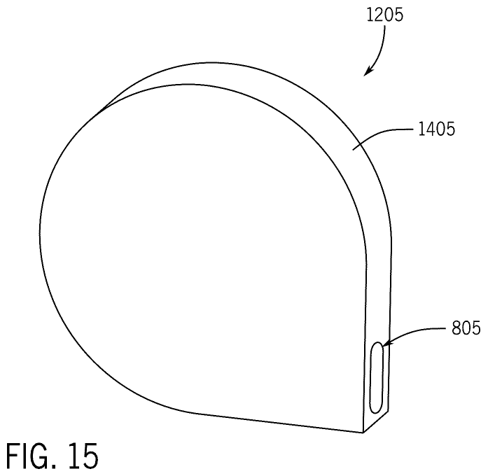

FIGS. 12-15 illustrate another example of a container 1200, as another example configuration of the schematically-illustrated arrangement of FIG. 3. The container 1200 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 1200.

In one example, the container 1200 includes a second receptacle 1205 configured to hold starting powder. The second receptacle 1205 may include a sidewall 1405 that defines a teardrop shape of the second receptacle 1205. For example, a first end of the second receptacle 1205 may define a rounded shape, while a second end of the second receptacle 1205 may define a pointed shape. In one example, the sidewall 1405 may define an opening 805 configured to permit an operator to pour starting powder out of the second receptacle 1205. The opening 805 may be arranged nearer the second, pointed end of the second receptacle 1205 to facilitate pouring starting powder from the opening 805.

In some examples, the second receptacle 1205 may be sized to be dimensionally smaller than an outer circumference of the rim 510 of the first receptacle 105. Thus, the second receptacle 1205 may be positioned on the first seal 305 of the first receptacle 105. In another example, in order to secure the second receptacle 1205 to the first receptacle 105, the adhesive 905 may be arranged on the first seal 305 of the first receptacle 105. In one example, the adhesive 905 may be arranged across the entire surface of the first seal 305. However, in other examples, the adhesive 905 may only be arranged in the center of the first seal 305 (e.g., as a dot of adhesive). Further, to retain the starting powder within the second receptacle 1205, a second seal (e.g., a plug, label, sticker, film, etc.) may be arranged over the opening 805. In some examples, the second seal may be arranged around the sidewall 1405 of the second receptacle 1205.

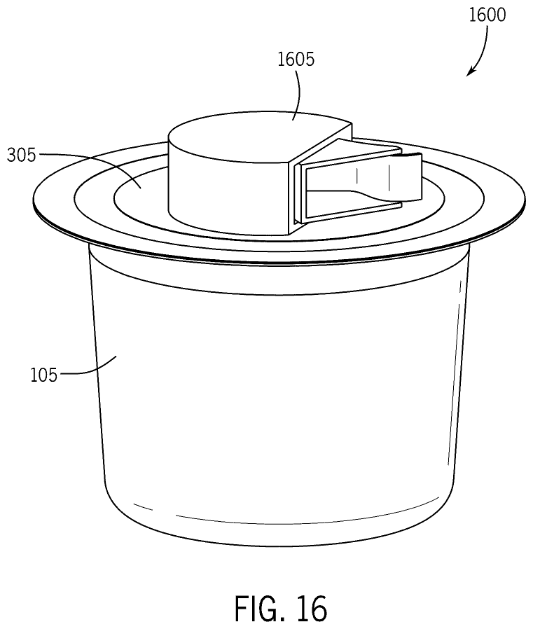

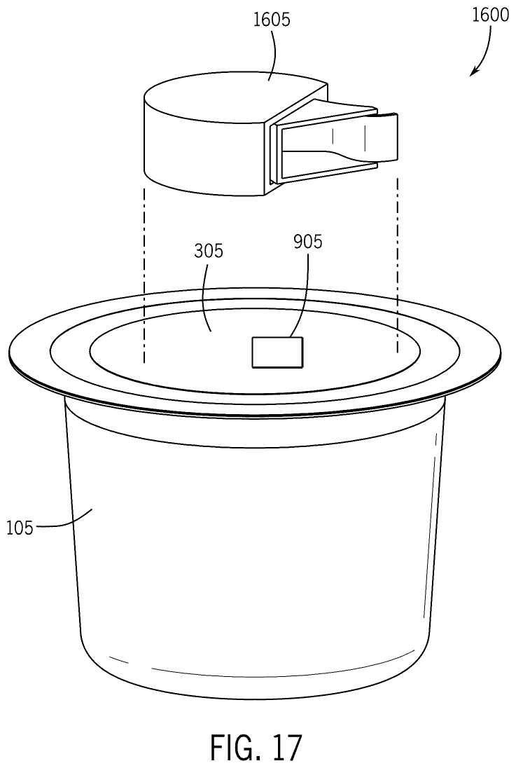

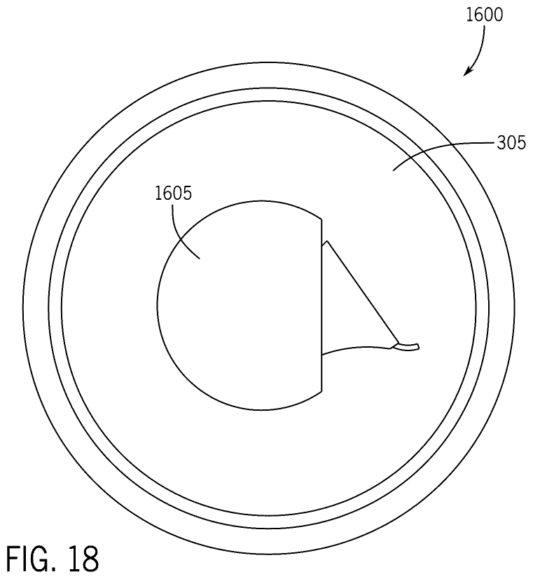

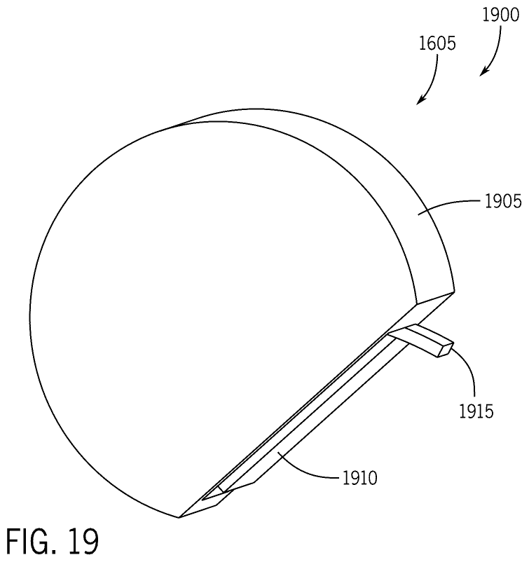

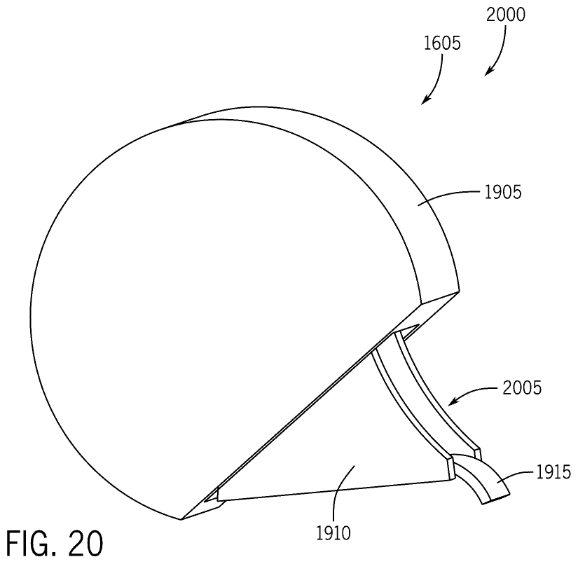

FIGS. 16-20 illustrate another example of a container 1600, as another example configuration of the schematically-illustrated arrangement of FIG. 3. The container 1600 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 1600.

In one example, the container 1600 includes a second receptacle 1605 configured to hold starting powder. The second receptacle 1605 may include a sidewall 1905 that defines a semi-circular shape of the second receptacle 1605. For example, a first end of the second receptacle 1605 may define a rounded shape, while a second end of the second receptacle 1605 may define a substantially flat shape. In one example, the second end of the second receptacle 1605 may include a spout 1910 that may rotate from a first position 1900 (e.g., a closed position) to a second position 2000 (e.g., an opened position). In some examples, the spout 1910 may be rotated from the first position 1900 to the second position 2000 via a force applied to a tab 1915 (e.g., a via an operator pulling on tab 1915). In some examples, the operator may apply a force to the tab 1915 to move the spout 1910 into the second position 2000 in order to expose an opening 2005, which may permit the operator to pour starting powder from the opening 2005.

In some examples, the second receptacle 1605 may be sized to be dimensionally smaller than an outer circumference of the rim 510 of the first receptacle 105. Thus, the second receptacle 1605 may be positioned on the first seal 305 of the first receptacle 105. In another example, in order to secure the second receptacle 1605 to the first receptacle 105, the adhesive 905 may be arranged on the first seal 305 of the first receptacle 105. In one example, the adhesive 905 may be arranged across the entire surface of the first seal 305. However, in other examples, the adhesive 905 may only be arranged in the center of the first seal 305 (e.g., as a dot of adhesive). Further, to retain the starting powder within the second receptacle 1605, a second seal (e.g., a plug, label, sticker, film, etc.) may be arranged over the spout 1910 (e.g., when the spout 1910 is in the first position 1900). In some examples, the second seal may be arranged around the sidewall 1905 of the second receptacle 1605.

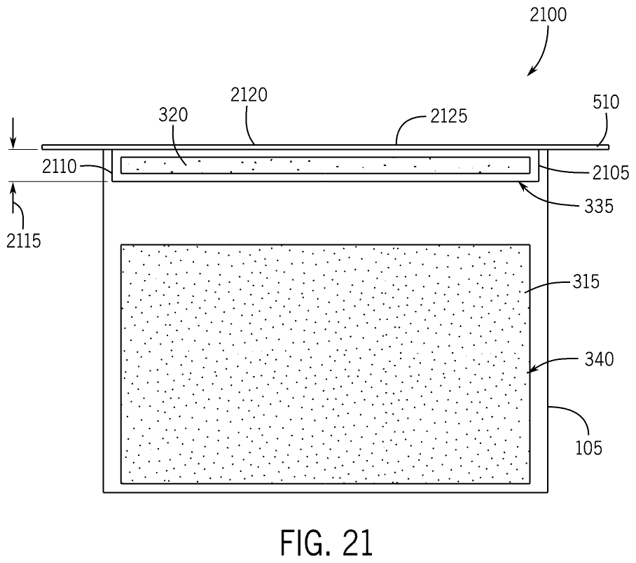

FIG. 21 illustrates another example of a container 2100, as another example configuration of the schematically-illustrated arrangement of FIG. 3. The container 2100 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 2100.

In one example, the container 2100 may include a second receptacle 2105 configured to hold starting powder 320. The second receptacle 2105 may include a sidewall 2110 that defines an outer circumference of the second receptacle 2105. In some examples, the outer circumference of the second receptacle 2105 is defined by the sidewall 2110 and may be dimensionally smaller than an inner circumference of the rim 510 of the first receptacle 105. Thus, the second receptacle 2105 may nest within the first receptacle 105, with the second receptacle 2105 recessed within the first receptacle 105 as shown by arrow 2115. In some examples, the recession of the second receptacle 2105 within the first receptacle 105 may arrange a surface 2120 of the second receptacle 2105 flush with a surface 2125 of the rim 510 of the first receptacle 105. In some examples, the second receptacle 2105 may serve as a seal to seal the weld material 315 within the first receptacle 105 (e.g., instead of the first seal 305).

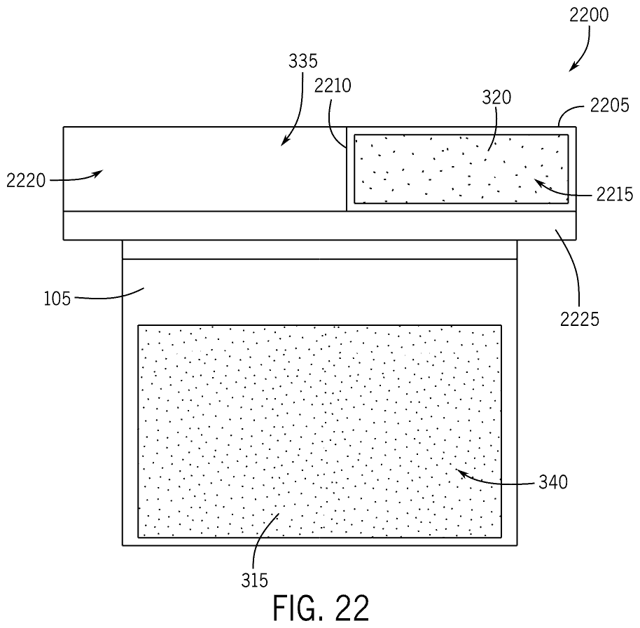

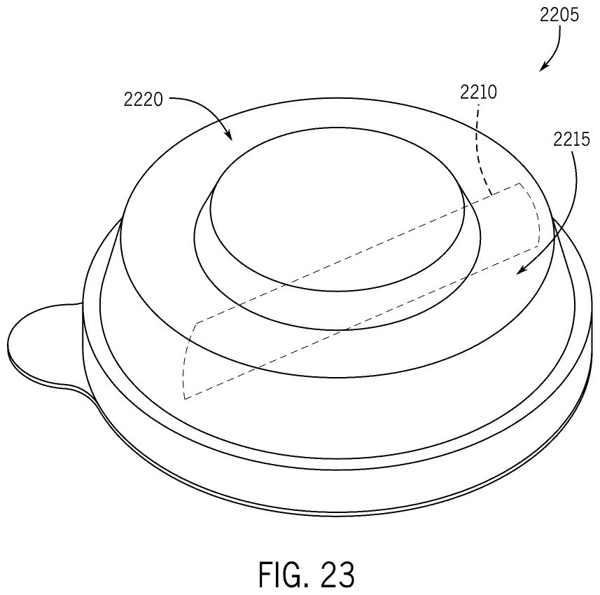

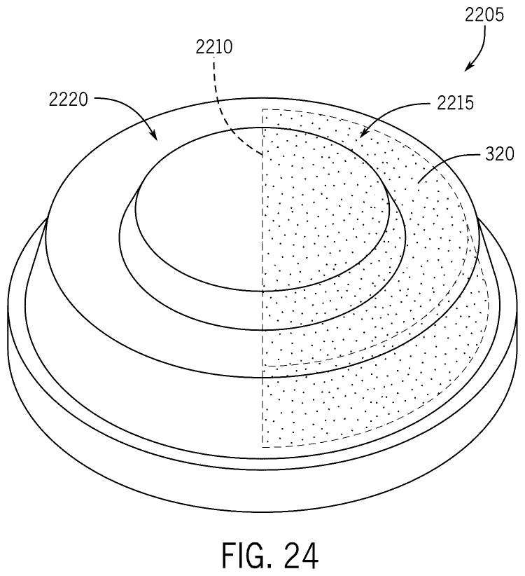

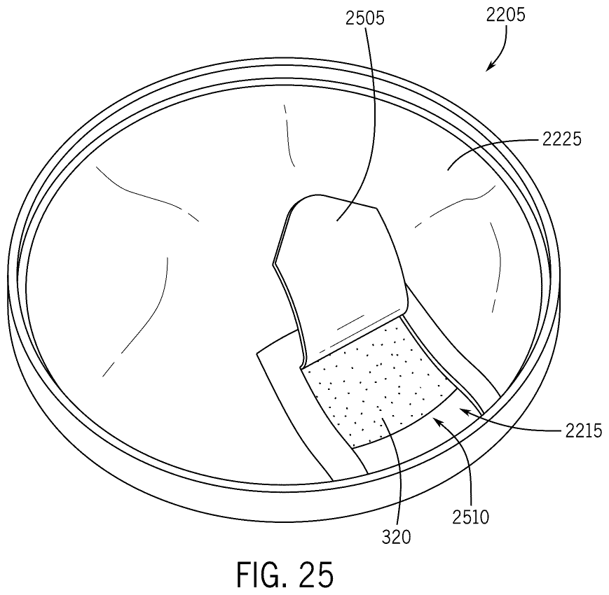

FIGS. 22-25 illustrate another example of a container 2200, as another example configuration of the schematically-illustrated arrangement of FIG. 3. The container 2200 shares a number of components in common with and operates in a similar fashion to the examples illustrated and described previously (e.g., the container 100). For the sake of brevity, these common features will not be again described below in detail. Rather, previous discussion of commonly named or numbered features, unless otherwise indicated, also applies to example configurations of the container 2200.

In one example, the container 2200 may include a second receptacle 2205 configured to hold starting powder 320. Further, the second receptacle 2205 define the interior volume 335, that may be separated via a divider 2210 into a first interior volume 2215 and a second interior volume 2220. In some examples, the first interior volume 2215 may be configured to hold the starting powder 320, while the second interior volume 2220 may be empty (e.g., not holding the starting powder 320).

In some examples, this configuration may permit the use of a smaller amount (e.g., volume) of starting powder 320 as the starting powder is held in the smaller first interior volume 2215. Thus, there may be less space for the starting powder 320 to generate friction or adhere to the interior of the second receptacle 2205, which may make pouring of the starting powder 320 from the second receptacle 2205 difficult.

Depending on the use case of the container 2200, the divider 2210 may be positioned in various locations within the interior volume 335 of the second receptacle 2205. For example, to facilitate the use of a larger amount of starting powder 320, the divider 2210 may be positioned to define a larger first interior volume 2215. Correspondingly, the divider 2210 may be positioned to define a smaller first interior volume 2215 in application that may require a smaller amount of starting powder 320. Thus, the divider 2210 may be positioned anywhere in the interior volume 335 of the second receptacle 2205 depending on the use case. Further, the divider 2210 may separate the first and second interior volumes 2215, 2220 to prevent starting powder 320 from passing into the second interior volume 2220.

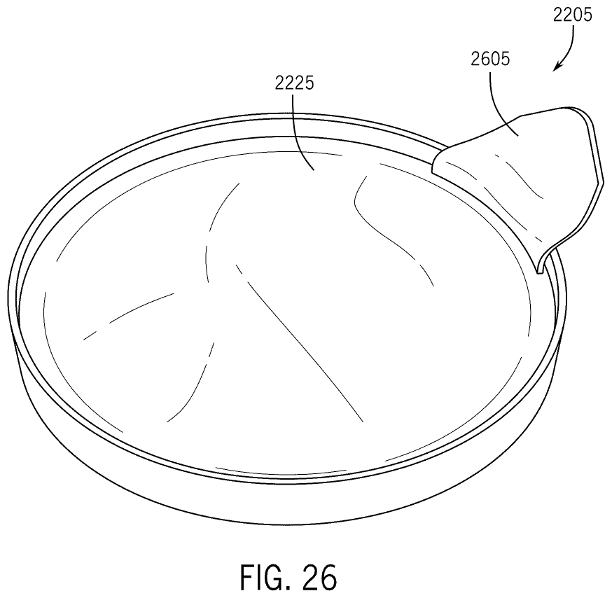

In some examples, in order to remove starting powder 320 from the first interior volume 2215, a seal 2225 (e.g., to seal starting powder within the interior volume 335) may include a tab 2505. The tab 2505 be pulled by an operator to separate the tab 2505 from the seal 2225 so that an opening 2510 is revealed. The opening 2510 may permit access to the first interior volume 2215, so that an operator may pour starting powder 320 out of the first interior volume 2215 via the opening 2510. In some examples, the second receptacle 2205 may be resealable via the tab 2505 (e.g., forming a multi-use receptacle, to save material for future use, etc.). In other examples, the second receptacle 2205 may be a single-use receptacle. For example, the tab 2505 may not be resealable onto the seal 2225 of the second receptacle 2205. In some examples, rather than utilizing the tab 2505, the seal 2225 may alternatively utilize a tab 2605 (see, e.g., FIG. 26). Similar to the tab 2505, the tab 2605 may be pulled by an operator to separate the seal 2225 from the second receptacle 2205 (e.g., to provide access to the first interior volume 2215). In some examples, the tabs 2505, 2605 may be integrally formed with and form a part of the seal 2225.

In some examples, the tabs 2505, 2605 may be pulled by an operator to separate the seal 2225 from the second receptacle 2205 (e.g., to provide access to the interior volume 335) instead of separating the tab 2605 from the seal 2225 itself (e.g., to provide access to the first interior volume 2215).

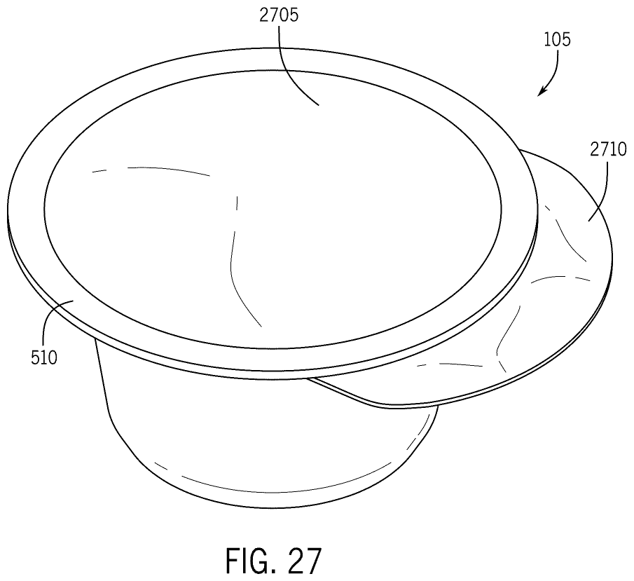

FIG. 27 illustrates another example of a seal 2705 for the first receptacle 105, as another example configuration of the schematically-illustrated seal 305 of FIG. 3. The seal 2705 shares a number of components in common with and operates in a similar fashion to the examples illustrated and described previously (e.g., the seal 305). For the sake of brevity, these common features will not be again described below in detail. Rather, previous discussion of commonly named or numbered features, unless otherwise indicated, also applies to example configurations of the seal 2705.

In one example, the seal 2705 may include a tab 2710, which may be pulled by an operator to separate the seal 2705 from the first receptacle 105. In some examples, the tab 2710 may protrude beyond the rim 510 of the first receptacle 105 to permit an operator to grip the tab 2710 and separate (e.g., pull) the seal 2705 from the first receptacle 105 to provide access to the interior volume 340 of the first receptacle 105. In some examples, the tab 2710 may be integrally formed with and form a part of the seal 2705.

In some examples, the seals (e.g., seals 305, 2225, 2705) may be used in place of a disk (e.g., metal disk 34) to support exothermic material (e.g., weld material, starting powder, etc.). For example, the seal (e.g., seals 305, 2225, 2705) may be removed (e.g., peeled) from the respective first receptacle (e.g., first receptacle 105) or second receptacle (e.g., second receptacle 110, 610, 810, 1010, 1205, 1605, 2105, 2205) and then positioned in the crucible chamber 30 over the tap hole 32. Following this, an appropriate amount of exothermic material (e.g., weld material) 36 can be placed into the crucible chamber 30 on top of the seal, and the starting powder 40 may be sprinkled over the top of the exothermic welding material 36 prior to ignition. The mold cover 20 may then be closed and the exothermic reaction initiated by igniting the starting powder 40 (e.g., via the use of an electrical ignitor, flint ignitor, etc.).

As should be appreciated, depending on the intended use case, the operator may utilize only one of the seals to support the exothermic material. For example, the operator may use only the seal 305, 2705 from the first receptacle 105. In another examples, the operator may use only the seal 2225 from the second receptacle (e.g., second receptacles 110, 610, 810, 1010, 1205, 1605, 2105, 2205). In yet another example, the operator may utilize both of the seals (e.g., the seal 305, 2705 from the first receptacle 105 and the seal 2225 from the second receptacle 110, 610, 810, 1010, 1205, 1605, 2105, 2205).

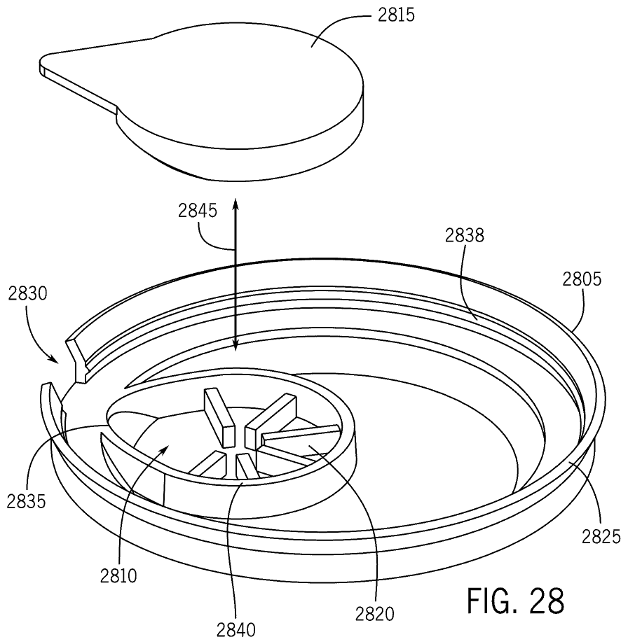

FIG. 28-30 illustrate another example of a second receptacle 2805, as another example configuration of the schematically-illustrated second receptacle 110 of FIG. 3. The second receptacle 2805 shares a number of components in common with and operates in a similar fashion to the examples illustrated and described previously (e.g., the second receptacle 110 generally, and specific examples thereof as discussed above). For the sake of brevity, these common features will not be again described below in detail. Rather, previous discussion of commonly named or numbered features, unless otherwise indicated, also applies to example configurations of the second receptacle 2805.

In some examples, the second receptacle 2805 may include a lid 2815 (e.g., a second seal) configured to selectively cover a cavity 2810 of the second receptacle 2805. For example, the lid 2815 may be used in lieu of the seal (e.g., seal 2225, etc.) described previously to cover the cavity 2810 to retain starting powder within an internal volume of the cavity 2810).

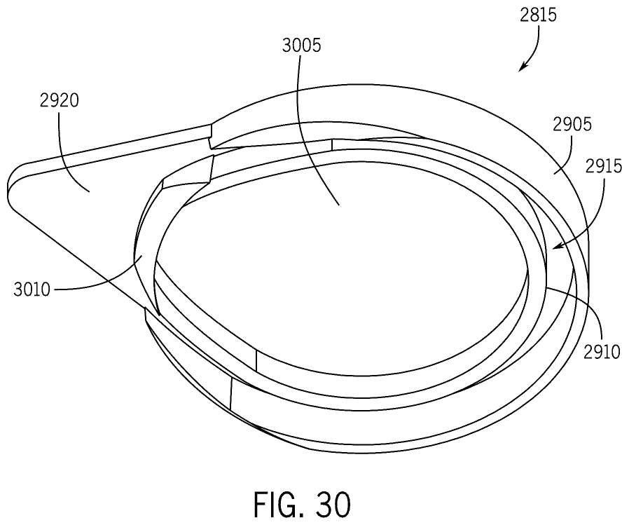

In the illustrated example, a wall 2840 may extend integrally from the second receptacle 2805 to define an outer perimeter of the cavity 2810. In some examples, the outer perimeter of the cavity 2810 may define a teardrop shape or otherwise taper. Thus, for example, the wall 2840 can form a funnel 2835 to permit an operator to easily pour starting powder from the cavity 2810. In some examples, including as illustrated in FIG. 28, the bounding wall(s) of the cavity 2810 may taper along multiple axes (e.g., laterally inwardly and axially upwardly as in FIG. 28) to help pour the starting powder. A corresponding taper may also be provided on a lid (e.g., as shown in FIG. 30), to ensure appropriate sealing of the cavity 2810.

In some examples, to facilitate the pouring of starting powder from the cavity 2810, a rim 2825 of the second receptacle 2805 may include a window 2830. The window 2830 may be aligned with the funnel 2835 so that starting powder may pour from the cavity 2810 via the funnel 2835 and through the window 2830. In some cases, in particular, the window 2830 may interrupt a lip or other protrusion that secures the second receptacle 2805 to a first receptacle, as further discussed below.

In some examples, to mitigate the risk of the starting powder within the cavity 2810 moving around, the cavity may optionally include one or more fins 2820. The fins 2820 may separate the cavity 2810 into individual compartments, each (or some) of which may contain starting powder.

In some examples, the lid 2815 may be secured to the wall 2840 of the cavity 2810 without the use of fasteners or adhesive (e.g., via a snap-fit or press-fit connection). For example, the rim 2825 can extend around the cavity 2810 to provide a resiliently deformable annular (or other) structure to removably engage a corresponding structure on another body (e.g., a flange on first the receptacle 105). However, in other examples, the lid 2815 may be secured to the second receptacle 2805 (e.g., to cover the cavity 2810) via a threaded connection, or any other known connection type. Put differently, the lid 2815 may be variously designed to be removable from and replaceable on the second receptacle 2805 (e.g., as shown by arrows 2845), so that an operator may save a portion of the starting powder, if desired. However, use of a rim as illustrated can be particularly beneficial in some cases, including to facilitate easier handling during manufacturing or installation, improved to guide pouring (or other flowing) of starting powder, and other benefits described herein.

In some examples, in order to secure the lid 2815 to the cavity 2810, the lid 2815 may include a first (e.g., outer) wall 2905 and a second (e.g., inner) wall 2910, which together form a groove 2915. Thus, in some examples, to secure the lid 2815 to the cavity 2810 an operator (e.g., human operator or automated manufacturing system) may arrange the wall 2840 of the cavity 2810 within the groove 2915 formed by the first and second walls 2905, 2910. However, in other examples, the lid 2815 may include only a single wall, which may be received in a groove defined by a pair of walls extending from the second receptacle. Following this, the operator may apply a force in the direction shown by arrow 2940 to secure the lid 2815 over the cavity 2810 (e.g., with press-fit or snap-fit engagement. In some examples, once the lid 2815 is secured in position, a chamfered portion 3010 of the lid 2815 may contact an angled wall 2935 of the cavity 2810.

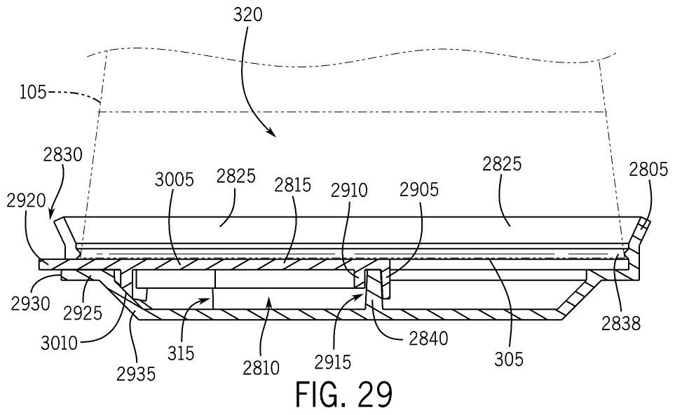

In particular, as shown in FIGS. 29 and 30, the lid 2815 may include a body 3005 and the nose portion 2920 extending away from the body 3005. In some examples, the body 3005 may define a circular shape, while the nose portion 2920 may define a triangular shape. In some examples, the nose portion 2920 may be configured to protrude to or past an edge 2930 of the second receptacle 2805 to allow application of leveraged force for easier removal of the lid 2815 from covering the cavity 2810. For example, when the lid 2815 is positioned over the cavity 2810 for transport of the unified container assembly, the nose portion 2920 may protrude through the window 2830, e.g., with an end of the nose portion 2920 accordingly also extending past the edge 2930 of the second receptacle 2805. Thus, an operator may be able to easily grip and remove the lid 2815 (e.g., to expose the starting powder within the cavity 2810). Further, when the lid 2815 is secured in position, a nose portion 2920 of the lid 2815 may contact a deck 2925 of the second receptacle 2805. Thus, for example, the nose portion 2920 can protrude to be easily accessible for removal once the second receptacle 2805 is separated from the first receptacle (e.g., the receptacle 105), while also being firmly secured against accidental removal when the receptacles are secured together (e.g., sandwiched between the snap-engaged first receptacle 105 and the deck 2925, as shown in FIG. 29).

Similarly, the extension of the rim 2825 and the outward angle of the rim 2825 (e.g., relative to the inward protrusion of the lip 2838) can assist in improved operator experience. For example, as well as providing convenient surfaces for automated handling, the outwardly extending rim 2825 can provide an easily accessible edge for users to apply leverage for removal of the second receptacle 2805 from the relevant first receptacle for a welding operation.

Thus, the second receptacle 2805 can provide both convenient operation for welding and more easily automatable manufacturing. Further, some examples can provide particularly secure assemblies for manufacturing and transport. For example, as illustrated in FIG. 29, the unified assembly of the first receptacle 105 and the second receptacle 2805 can enclose the seal 305 and the lid 2815 (at the cavity 2810—but not at the nose portion 2920, for example). Thus, for example, the molded, metal, or other bodies of the receptacles 105, 2805 can help to not only to reliably (and separately) retain the welding material and starting powder for a welding operation but also to protect potentially weaker or more flexible closures of the relevant interior volumes (e.g., lids or foil seals).

In some examples, the second receptacle 2805 and the lid 2815 may be manufactured using an injection molding process (e.g., from a polymeric material, plastic material, metallic material, etc.). However, in other examples, the second receptacle 2805 and the lid 2815 may be thermoformed (e.g., from a polymeric or plastic material). In some cases, for example when the lid 2815 is made from a metal or metallic material, the lid 2815 may be used in place of a disk (e.g., metal disk 34) to support exothermic material (e.g., weld material, starting powder, etc.). For example, the lid 2815 may be removed from the second receptacle (e.g., second receptacle 2805) and then positioned in the crucible chamber 30 over the tap hole 32. Following this, an appropriate amount of exothermic material (e.g., weld material) 36 can be placed into the crucible chamber 30 on top of the seal, and the starting powder 40 may be sprinkled over the top of the exothermic welding material 36 prior to ignition. The mold cover 20 may then be closed and the exothermic reaction initiated by igniting the starting powder 40 (e.g., via the use of an electrical ignitor, flint ignitor, etc.).

In some cases, for example when the lid 2815 is made from a plastic or polymeric material, the second receptacle 2805 and the lid 2815 may be transparent (or partially transparent) to permit an operator to view the starting powder within the cavity 2810. In some examples, the second receptacle 2805 may be transparent, while the lid 2815 may be color coded according to an amount of starting powder within the cavity 2810. In some examples, the lid 2815 may not be fully removable, but may instead be movable relative to the second receptacle 2805 to open the cavity 2810 to release the starting powder (e.g., as variously discussed for other examples above).

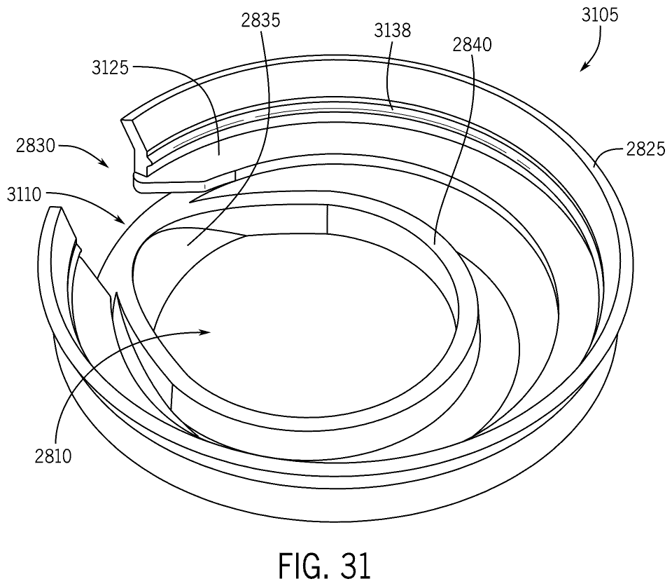

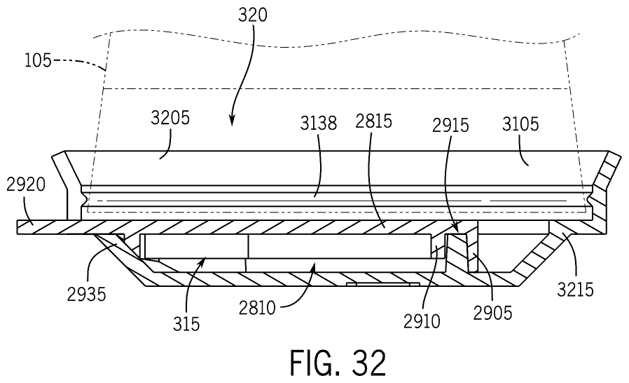

FIGS. 31 and 32 illustrate another example of a second receptacle 3105, as another example configuration of the schematically-illustrated second receptacle 110 of FIG. 3. The second receptacle 3105 shares a number of components in common with and operates in a similar fashion to the examples illustrated and described previously (e.g., the second receptacle 110 generally, or the second receptacle 2805 in particular). For the sake of brevity, these common features will not be again described below in detail. Rather, previous discussion of commonly named or numbered features, unless otherwise indicated, also applies to example configurations of the second receptacle 3105.

In some examples, as shown in FIG. 31 in particular, in order to permit a lid (e.g., the lid 2815) to sit flush with a deck 3125 (or other surface) of the second receptacle 3105, the deck 3125 may include a cutout 3110. The cutout 3110 may be shaped to permit the nose portion 2920 of the lid 2815 to sit within the cutout 3110, e.g., so that the lid 2815 is fully recessed within the cutout 3110 to sit flush with the deck 3125. As a result, as shown in FIG. 32 in contrast to FIG. 29, greater clearance may be provided between a protrusion on a locking rim 3205 of the second receptacle 3105 (e.g., a snap-engagement lip 3138 to secure the second receptacle 3105 to the first receptacle) as compared to the second receptacle 3105 without the cutout 3110). Thus, in some examples, the second receptacle 3105 may reduce the risk of clearance or fitment issues when securing the second receptacle 3105 to the first receptacle.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

In that regard, for example, a method of manufacturing the container 100 may include pouring or otherwise filling a first ignitable material (e.g., exothermic welding material) into the first receptacle 105 via the opening 330, and then sealing the volume 340 of the first receptacle 105 (e.g., by securing a first seal 305 over the opening 330 of the first receptacle 105). Separately (e.g., on a separate manufacturing line), a second, different ignitable material (e.g., starting powder) can be poured or otherwise filled into the second receptacle 110 via opening 325 and the volume 335 of the second receptacle 110 can then be sealed (e.g., by securing a second seal 310 over the opening 325). With the ignitable materials thus contained in the separate respective sealed volumes 335, 340, the second receptacle 110 can be removably secured to the second end 210 of the first receptacle 105 (e.g., via the snap-fit connection 115).

In a particular example, a method of manufacturing may include filling a first ignitable material (e.g., exothermic welding material) via the opening 330 defined by the first receptacle 105, and scaling the volume 340 of the first receptacle 105 (e.g., by securing a first seal 305 over the opening 330 of the first receptacle 105). Separately (e.g., in a separate, blast-proof room), a second, different ignitable material (e.g., starting powder) can be filled into the cavity 2810 defined by the second receptacle 2805 and the cavity 2810 of the second receptacle 2805 can be sealed (e.g., by securing a lid 2815 over the cavity 2810). With the ignitable materials thus contained in the separate respective sealed volumes, the second receptacle 2805 can be removably secured to the second end 210 of the first receptacle 105 (e.g., via the snap-fit connection 115).

Relatedly, the disclosed technology can provide improved methods of use for welding operations. For example, an operator (e.g., an operator wearing gloves, etc.) may easily separate the first receptacle (e.g., first receptacle 105) from the second receptacle (e.g., second receptacle 2805) via the rim (e.g., rim 2825) of the second receptacle. Following this, the operator may remove the seal (e.g., seal 305) from the first receptacle to permit access to the interior volume of the first receptacle and weld material (e.g., weld material 315). Further, the operator may easily separate the lid (e.g., lid 2815) from the second receptacle (e.g., via the protrusion (e.g., protrusion 2920)) without needing to remove gloves, etc. Once the operator has removed the lid, the operator may pour starting powder (e.g., starting powder 320) from the cavity (e.g., cavity 2810), through the window (e.g., window 2830) and into the first receptacle (e.g., to mix the starting powder with the weld material). The operator may then ignite the mixture of starting powder and weld material to facilitate the exothermic welding process and form a weld.

As should be appreciated, the above-described methods may be utilized with any of the variations of the second receptacles described above (e.g., second receptacles 110, 610, 810, 1010, 1205, 1605, 2105, 2205, 2805, 3105).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within +12 degrees of a reference direction (e.g., within +6 degrees), inclusive.

Also as used herein, unless otherwise limited or defined, “substantially perpendicular” indicates a direction that is within +12 degrees of perpendicular a reference direction (e.g., within +6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together into a unified assembly, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A container for exothermic welding material, comprising:
a first receptacle that defines a first internal volume that contains welding material, and a first opening into the first internal volume; and
a second receptacle that defines a second internal volume that contains starting powder, and a second opening into the second internal volume;
the second receptacle being removably secured to the first receptacle to form a unified assembly, with the first and second openings closed to separate the starting powder from the welding material.

2. The container of claim 1, wherein the second receptacle is removably secured to the first receptacle via a snap-fit connection between the second receptacle and the first receptacle.

3. The container of claim 2, wherein the second receptacle includes a circumferential rim that extends around the second opening of the second receptacle and snap-engages a circumferential flange extending around from the first opening of the first receptacle.

4. The container of claim 3, wherein one or more of a cover that removably closes the second opening or an access opening for the cover protrudes through the circumferential rim.

5. The container of claim 1, further comprising:
a first seal removably secured to seal the first opening; and
a second seal removably secured to seal the second opening.

6. The container of claim 1, wherein the first and second seals, at the first and second openings, respectively, are collectively enclosed by the first and second receptacles.

7. The container of claim 1, further comprising:
a circumferential lip formed on one of the first receptacle or the second receptacle that removably engages the other of the first receptacle or the second receptacle.

8. The container of claim 7, wherein the lip is formed on the second receptacle, protruding inwardly from a rim of the second receptacle; and
wherein the rim extends beyond, and angles outwardly away, from the lip.

9. The container of claim 1, wherein the first internal volume contains the welding material independently of the second receptacle; and
wherein the second internal volume contains the starting powder independently of the first receptacle.

10. The container of claim 1, wherein the second opening is closed by a lid that includes:
a body; and
a nose portion, the nose portion extending from the body toward or past an exterior edge of the second receptacle to permit removal of the lid from the second receptacle.

11. The container of claim 10, wherein the nose portion of the lid extends past the exterior edge through a window defined in a rim of the second receptacle that secures the second receptacle to the first receptacle.

12. A method of manufacturing a container for exothermic welding material, comprising:
filling welding material into a first internal volume of a first receptacle via a first opening defined at a first end of the first receptacle;
closing the first opening to retain the welding material within the first receptacle by removably securing a first seal to the first receptacle;
filling starting powder into a second internal volume of a second receptacle via a second opening defined at a second end of the second receptacle;
closing the second opening to retain the starting powder within the second receptacle by removably securing a second seal to the second receptacle; and
after closing the first and second openings, securing the first end of the first receptacle to the second end of the second receptacle to form a unified assembly.

13. The method of claim 12, wherein the second receptacle is secured to the first receptacle via a snap-fit connection.

14. The method of claim 12, wherein securing the first receptacle to the second receptacle includes:
engaging one or more protrusions extending from the second receptacle with a rim of a circumferential flange of the first receptacle.

15. The method of claim 12, wherein the second seal is a lid, including:
a body secured by press-fit attachment to close the second opening; and
a nose portion, the nose portion extending past an edge of the second receptacle when the lid is removably secured to the second receptacle to permit levered removal of the body from the press-fit attachment.

16. The method of claim 15, wherein the nose portion of the lid extends through a window defined by a rim of the second receptacle.

17. A container for exothermic welding material, comprising:
a first receptacle that defines a first volume, the first volume containing welding material;
a second receptacle, including:
a wall defining a cavity that contains starting powder; and
a lid removably secured to the wall to, in cooperation with the wall, fully enclose the cavity;
the second receptacle being removably secured to the first receptacle, to form a unified assembly.

18. The container of claim 17, wherein the lid at the cavity and a seal that closes the first volume are enclosed collectively by the first and second receptacles, in the unified assembly.

19. The container of claim 17, a wherein rim of the second receptacle defines a window; and
wherein the lid extends to or through the window.

20. The container of claim 17, wherein the wall one or more of:
defines a tapered shape to guide starting powder out of the cavity; or
is circumferentially enclosed by a rim of the second receptacle.
